(19) United States
(12) Patent Application Publication
(10) Pub. No.: US 2003/0210214 A1
(43) Pub. Date: Nov. 13, 2003

(54) Liquid crystal display device and liquid crystal display element drive method

(76) Inventors: Naoki Masazumi, Kobe-Shi (JP); Makiko Mandai, Takatsuki-Shi (JP)

Correspondence Address: SIDLEY AUSTIN BROWN & WOOD LLP, 717 NORTH HARWOOD, SUITE 3400, DALLAS, TX, 75201, US

(21) Appl. No.: 09/862,751

(22) Filed: May 22, 2001

(30) Foreign Application Priority Data
May 24, 2000 (JP) 2000-152505

(51) Int. Cl. G09G 3/36

(52) U.S. Cl. 345/87

(57) ABSTRACT

Disclosed is a liquid crystal display device that comprises a liquid crystal display element including stacked multiple display layers and a driver unit for the multiple display layers. Each of the multiple display layers comprises liquid crystal held between multiple scanning electrodes and multiple signal electrodes that face each other and are aligned in a perpendicular fashion. The drive unit impresses pulse voltage to the liquid crystal of each display layer via the scanning electrodes and signal electrodes in order to cause each display layer to perform display, said driver unit carrying out for each display layer a drive procedure including a reset period during which the liquid crystal is reset to the initial condition, a selection period during which the final display state is selected, an establishing period during which the state selected in the selection period is established. In this drive procedure, a length of time of selection pulses that are to be impressed during the selection period is set to be equal for each display layer.

### CROSS-REFERENCE TO RELATED APPLICATION

This application is based on Japanese Patent Application No. 2000-152505 filed in Japan on May 24, 2000, the entire content of which is hereby incorporated by reference.

### BACKGROUND OF THE INVENTION

1. Field of the Invention

The present invention relates to a liquid crystal display device and liquid crystal display element drive method, and more particularly, to a liquid crystal display device in which pulses of drive voltage are applied to the liquid crystal via multiple scanning electrodes and multiple signal electrodes that face each other and are aligned in a perpendicular fashion, as well as to a drive method for such a liquid crystal display element.

2. Description of the Related Art

Various types of reflective liquid crystal display elements using liquid crystal (mainly chiral nematic liquid crystal) that exhibits a cholesteric phase at room temperature have been developed and researched in recent years as media to reproduce digital information in the form of visible information, with an emphasis on their advantages of lower power consumption and low cost of manufacture. However, it has been found that a display element using this type of memory liquid crystal has the unique shortcoming of slow drive speed.

In light of this problem, U.S. Pat. No. 5,748,277 proposes a drive method for this type of liquid crystal display element. Using this drive method, the liquid crystal may be driven at a high speed using a low voltage.

The drive method includes, in order to display an image in the liquid crystal display element, (1) a period during which the liquid crystal is reset to the initial condition, (2) a selection period during which the final display state is selected, (3) a period during which the state selected during the selection period is established, and (4) a period during which the image is displayed. Incidentally, a problem has been identified that, where color display is performed using liquid crystal display layers that are stacked together and that display R, G and B colors, respectively, the response speed of the liquid crystal infused into each display layer varies from one display layer to another, such that when an optimal selection period is specified for each display layer, the scanning time varies from one display layer to another.

When the scanning times for the various display layers differ in this way, discrepancies in display occur among the display layers, resulting in images that are difficult to observe. In addition, when images are drawn repeatedly for the purpose of an animated display, for example, the problem arises that the images are difficult to recognize as a result of the display discrepancies described above, as well as because the next image draw in one layer begins before the image draw in another display layer is completed.

### SUMMARY OF THE INVENTION

The object of the present invention is therefore to provide a liquid crystal display device comprising multiple liquid crystal display layers stacked together, wherein the scanning times for each display layer may be set to be equal, as well as a liquid crystal display element drive method capable of setting the scanning times for each display layer to be equal.

Another object of the present invention is to provide a liquid crystal display device and a liquid crystal display element drive method that can set the timing at which scanning begins to be the same for each display layer at all times.

Yet another object of the present invention is to provide a liquid crystal display device and a liquid crystal display element drive method that can prevent display discrepancies among the display layers.

In order to attain these objects, the drive method pertaining to the present invention is a drive method for a liquid crystal display element comprising multiple display layers that are stacked together and in each of which pulses of drive voltage are impressed to the liquid crystal via multiple scanning electrodes and multiple signal electrodes that face each other and are aligned in a perpendicular fashion, wherein a drive procedure is carried out for each display layer, said procedure including a reset period during which the liquid crystal is reset to the initial condition, a selection period during which the final display state is selected, an establishing period during which the state selected during the selection period is established, and wherein the length of time during the selection period over which the selection pulses are impressed is set to be equal for each display layer.

The liquid crystal display device pertaining to the present invention includes a liquid crystal display element comprising multiple display layers that are stacked together, wherein each layer comprises liquid crystal held between multiple scanning electrodes and multiple signal electrodes that face each other and are aligned in a perpendicular fashion, and a drive unit that impresses pulse voltage to the liquid crystal of each display layer via the scanning electrodes and signal electrodes in order to cause each display layer to perform display, and wherein the drive unit carries out for each display layer a drive procedure including a reset period during which the liquid crystal is reset to the initial condition, a selection period during which the final display state is selected, an establishing period during which the state selected in the selection period is established, and wherein the length of time during the selection period over which the selection pulses are impressed is set to be equal for each display layer.

In the liquid crystal display device and drive method pertaining to the present invention, because the required length of time during the selection period over which selection pulses are impressed is set to be equal for each display layer, the scanning time may be made equal for each display layer. In particular, even where the selection period varies from one display layer to another, the scanning time from the onset of the reset period for one line to the completion of the establishing period may be made equal for each display layer by adjusting the length of the reset period and/or the establishing period.

Furthermore, by controlling the voltage level or pulse width of the selection pulses in the selection period, the liquid crystal molecules may be finally arranged in a focal conic state or a planar state, and moreover, if the voltage level or pulse width is controlled using multiple stages, the liquid crystal molecules may be finally arranged in a focal conic state, a planar state, or a mixture thereof.

### BRIEF DESCRIPTION OF THE DRAWINGS

These and other objects, advantages and features of the invention will be come apparent from the following description thereof taken in conjunction with the accompanying drawings in which:

FIG. 1 is a cross-sectional view showing one example of a liquid crystal display element in which the drive method pertaining to the present invention can be applied;

FIG. 2 is a block diagram showing the drive circuit of the liquid crystal display element;

FIG. 3 is a chart showing the basic drive waveforms in the drive method pertaining to the present invention;

FIG. 4 is a chart showing the drive waveforms in a first embodiment of the drive method pertaining to the present invention;

FIG. 5 is a chart showing the drive waveforms that are impressed to the overlapping pixels of each display layer in the first embodiment; and

FIG. 6 is a chart showing the drive waveforms that are impressed to the overlapping pixels of each display layer in a second embodiment of the drive method pertaining to the present invention.

### DETAILED DESCRIPTION OF THE PREFERRED EMBODIMENTS

The embodiments of the liquid crystal display device and the liquid crystal display element drive method pertaining to the present invention are explained below with reference to the accompanying drawings.

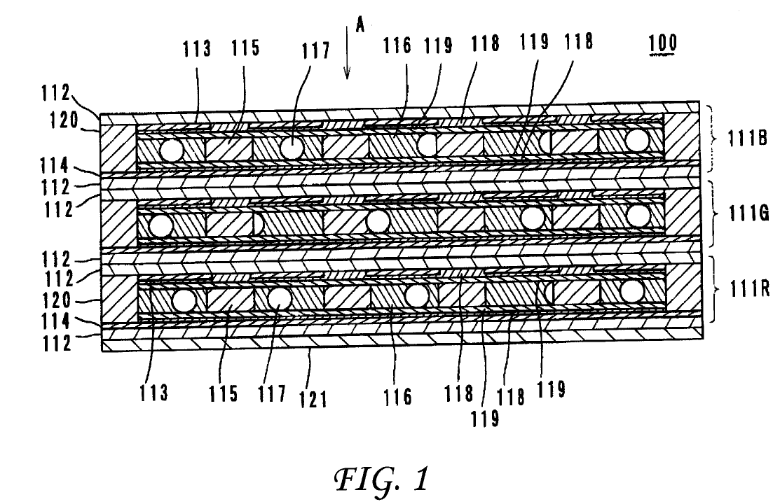

(Liquid crystal display element, see FIG. 1)

The liquid crystal display element including liquid crystal that exhibits a cholesteric phase and that is the object of the drive method pertaining to the present invention will first be explained.

FIG. 1 shows a reflective color liquid crystal display element using the simple matrix drive method. This liquid crystal display element 100 comprises a light-absorbing layer 121, a red display layer 111R that is placed on top of the light-absorbing layer 121 and that performs display through alternating between selective reflection of red and transparent state, a green display layer 111G that is placed on top of the red display layer and that performs display trough alternating between selective reflection of green and transparent state, and a blue display layer 111B that is placed on top of the green display layer and that performs display through alternating between selective reflection of blue and transparent sate.

The display layers 111R, 111G and 111B each comprise transparent substrates 112, each having transparent electrodes 113 and 114, as well as resin column bodies 115, liquid crystal 116 and spacers 117 held between the substrates. An insulating film 118 and an orientation control film 119 are placed on the transparent electrodes 113 and 114 where necessary. In addition, a sealing member 120 is placed on the periphery of the substrate 112 (outside the display area) with which to contain the liquid crystal 116.

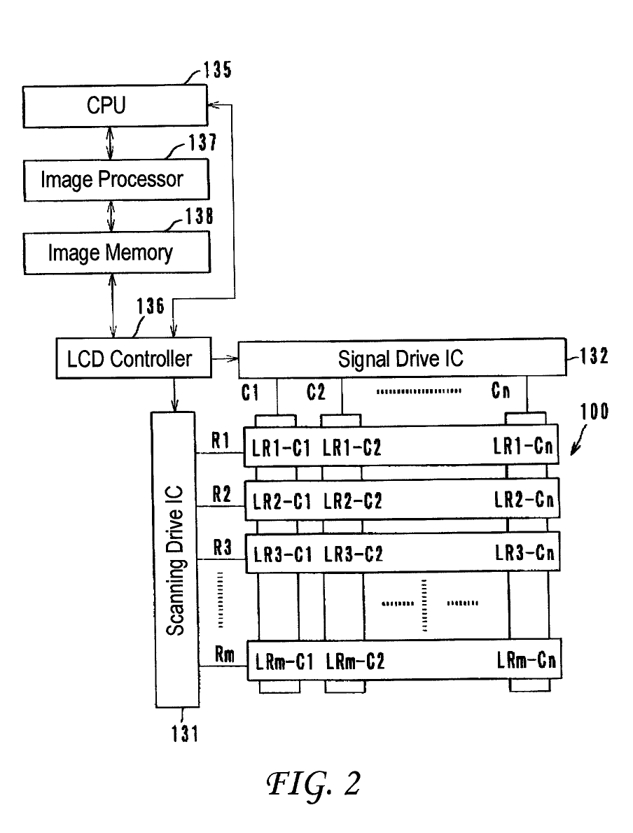

The transparent electrodes 113 and 114 are connected to drive ICs 131 and 132 (see FIG. 2), respectively, and prescribed pulse voltage is impressed to the transparent electrodes 113 and 114. In response to the impression of voltage, the liquid crystal 116 alternates the display between a transparent state in which it allows visible light to pass through and a selective reflection state in which it selectively reflects visible light of a specific wavelength.

The transparent electrodes 113 and 114 that are included in each display layer 111R, 111G and 111B comprise multiple belt-shaped electrodes that are arranged parallel to one another at minute intervals, and the transparent electrodes 113 and 114 face each other such that the belt-shaped electrodes are perpendicular to each other. Current is sequentially drawn to these upper and lower belt-shaped electrodes. In other words, voltage is sequentially impressed to each liquid crystal 116 in a matrix fashion and display is performed. This is called matrix driving, and the part at which an electrode 113 and an electrode 114 cross each other comprises a pixel. When such matrix driving is carried out for each display layer, color images are displayed on the liquid crystal display element 100.

To explain it in more detail, in a liquid crystal display element that holds liquid crystal that exhibits a cholesteric phase between two substrates, display is performed by alternating the state of the liquid crystal between planar state and focal conic state. Where the liquid crystal is in a planar state, if the helical pitch of the cholesteric liquid crystal molecules is P and the average refractive index thereof is n, light having the wavelength λ=P●n is selectively reflected. When the foca conic state is present, if the selective reflection wavelength of the cholesteric liquid crystal exists in the infrared light range, incident light is diffused, and if the selective reflection wavelength of the cholestseric liquid crystal is shorter than the infrared light range, visible light is allowed to pass through. Therefore, if the selective reflection wavelength is set to fall within the visible light range and a light-absorbing layer is placed on the side opposite the observer side of the element, the selective reflection color may be displayed when the planar state is present and black may be displayed when the focal conic state is present. If the selective reflection wavelength is set within the infrared light range and a light-absorbing layer is placed on the side opposite the observer side of the element, because light in the infrared light range is reflected but light in the visible light range is allowed to pass through, black may be displayed when the planar state is present, while white may be displayed due to diffusion when the focal conic state is present.

The liquid crystal display element 100 comprising display layers 111R, 111G and 111B stacked together is capable of performing red display when the blue display layer 111B and the green display layer 111G are transparent, i.e., when their molecules are arranged in a focal conic state, and the red display layer 111R is in the selective reflection state in which its molecules are arranged in a planar state. When the blue display layer 111B is in the transparent state in which its molecules are arranged in a focal conic state, and the green display layer 111G and the red display layer 111R are in the selective reflective state in which their molecules are arranged in a planar state, yellow may be displayed. Similarly, red, green, blue, white, cyan, magenta, yellow and black may be displayed by appropriately selecting the transparent state and selective reflection state for each display layer. Further, if an intermediate selective reflection state is selected as the state of each display layer 111R, 111G and 111B, halftone colors may be displayed, so that the liquid crystal display may be used as a color display element.

For the liquid crystal 116, a liquid crystal material that exhibits a cholesteric phase at room temperature is preferred. In particular, chiral nematic liquid crystal that may be obtained by adding a chiral dopant to a nematic liquid crystal material is preferred.

A chiral dopant is an additive that has the effect of inducing a twisted molecule alignment of nematic liquid crystal when added thereto. When a chiral dopant is added to nematic liquid crystal, a helical structure wherein the molecules have a prescribed helical distance is induced in the liquid crystal molecules, and a cholesteric phase is exhibited through this structure.

The liquid crystal display layers are not necessarily limited to this construction. Layers in which the resin bodies have the configuration of a dam, or those that do not include resin bodies, may also be used. In addition, the liquid crystal display layer may be constructed as a so-called polymer dispersion type liquid crystal composite film in which the liquid crystal is dispersed in the three-dimensional network of a conventionally known polymer, or in which the three-dimensional network structure of a polymer is formed in the liquid crystal.

(Drive circuit, see FIG. 2)

The pixels of the liquid crystal display element 100 are expressed in terms of a matrix of multiple scanning electrodes R1, R2, . . . Rm and multiple signal electrodes C1, C2, . . . Cn (m and n being natural numbers). The scanning electrodes R1, R2, . . . Rm are connected to the output terminals of the scanning drive IC 131, while the signal electrodes C1, C2, . . . Cn are connected to the output terminals of the signal drive IC 132.

The scanning drive IC 131 outputs a selection signal to prescribed electrodes among the scanning electrodes R1, R2, . . . Rm to make them selected, while it outputs a non-selection signal to others to make them non-selected. The scanning drive IC 131 sequentially impresses a selection signal to the scanning electrodes R1, R2, . . . Rm while switching from one electrode to another at prescribed intervals. On the other hand, the signal drive IC 132 simultaneously outputs to the signal electrodes C1, C2, . . . Cn signals based on the image data in order to redraw each pixel on the selected scanning electrodes R1, R2, . . . Rm. For example, where the scanning electrode Ra is selected (a being a natural number that satisfies a ≦ m), the pixels LRa-C1 through LRa-Cn at the intersection points of this scanning electrode Ra and the signal electrodes C1, C2, . . . Cn are simultaneously redrawn. Through this operation, the difference in voltage between the scanning electrode and the signal electrode at each pixel operates as the redraw voltage for that pixel, and each pixel is redrawn in accordance with this redraw voltage.

The drive circuit comprises a central processing unit (CPU) 135, an LCD controller 136, an image processor 137, an image memory 138 and drive ICs (drivers) 131 and 132. The LCD controller 136 controls the drive ICs 131 and 132 based on the image data stored in the image memory 138, sequentially impresses voltage to each scanning electrode and signal electrode of the liquid crystal display element 100, and draws an image in the liquid crystal display element 100.

Where the image is to be partially redrawn, only specific scanning lines should be sequentially selected so as to include only the target redraw area. Through this operation, only the desired area may be redrawn in a short period of time.

Each pixel may be redrawn in the manner described above, and where an image is already being displayed, it is preferred that all pixels be reset to the same display condition before redraw in order to eliminate any influence from the present image. Resetting may be carried out for all pixels simultaneously, or separately for each scanning electrode.

Where partial redraw is to be performed, the pixels should be reset separately for each scanning line, or pixels on only the specific scanning lines including the target redraw area should be simultaneously reset.

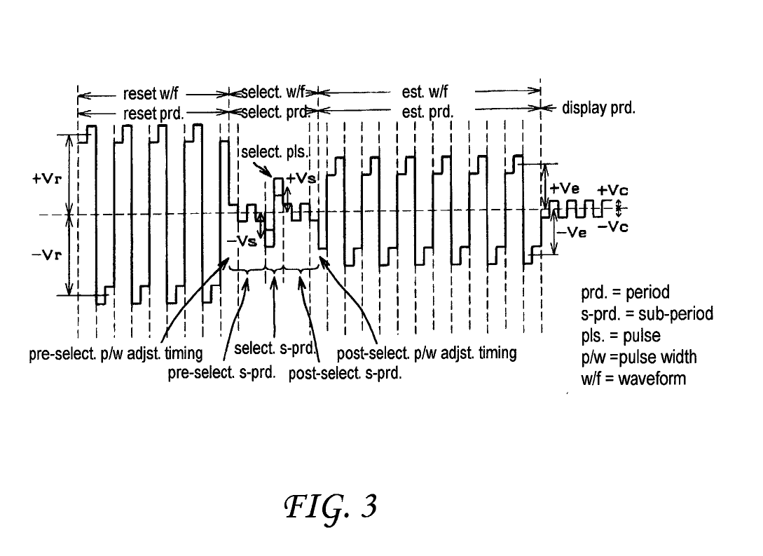

(Drive method, see FIG. 3)

The basic principle of the drive method of the liquid crystal display element 100 will first be explained. A specific example using alternating pulse waveforms is used in this explanation but needless to say, the drive method is not limited to these waveforms.

The drive method of this example comprises essentially (1) a reset period, (2) a selection period, (3) an establishing period and (4) a display period (which may also be referred to as a ‘cross-talk period’). During the reset period, the liquid crystal is reset to a homeotropic state, in the selection period, voltage to select the final display sate is impressed, and in the establishing period, the state selected during the selection period is established.

The reset period may be divided into multiple sub-periods or cycles with the length of the selection pulse as one cycle. FIG. 3 shows a situation in which the reset period is divided into eight reset cycles. In each reset cycle, pulses of ± (Vr±Vc) voltage are each impressed for half a cycle. The collection of these pulses over multiple cycles is termed the reset waveform.

Similarly, the establishing period may be divided into multiple sub-periods or cycles as well. FIG. 3 shows a situation in which the establishing period is divided into 12 cycles. In each maintenance cycle, pulses of ±(Ve±Vc) voltage are each impressed for half a cycle. The collection of these pulses over multiple cycles is termed the maintenance waveform.

During the display period, cross-talk pulses of ±Vc voltage are impressed as selection signals to select pixels on other scanning lines. The voltage level Vc of the cross-talk pulse is set to be smaller than the threshold value that alters the liquid crystal. When the image redraw is completed and establishing period has elapsed regarding all pixels, the operation of the drive ICs 131 and 132 may be stopped such that the impressed voltage becomes zero.

The selection period comprises a pre-selection sub-period, a selection sub-period and a post-selection sub-period. During the pre-selection sub-period and the post-selection sub-period, cross-talk pulses of ±Vc voltage are impressed. During the selection sub-period, selection pulses are impressed. The voltage level of the selection pulse ranges between Von (±(Vs+Vc)) and Voff (±(Vs·Vc)).

The liquid crystal operates in the following manner. First, the reset waveform is impressed during the reset period, and the liquid crystal is reset to a homeotropic condition. The molecules of the liquid crystal then become slightly twisted during the pre-selection sub-period. The waveform of the selection pulses impressed during the subsequent selection sub-period varies between the pixels as to which the planar state is ultimately selected and the pixels for which the focal conic state is ultimately selected.

The case in which the planar state is selected will first be explained. In this case, selection pulses of ±(Vs+Vc) voltage are impressed during the selection sub-period to reset the liquid crystal to a homeotropic condition once more. When cross-talk pulses of ±Vc voltage are then impressed during the post-selection sub-period, the liquid crystal molecules become slightly twisted. The maintenance waveform is then impressed during the establishing period. The molecules of the liquid crystal that became slightly twisted during the post-selection sub-period become untwisted again with the impression of the maintenance waveform, and ultimately return to the homeotropic condition.

During the display period, when the voltage impressed to the liquid crystal becomes zero or ± Vc (cross-talk pulses), the liquid crystal enters a planar state. Liquid crystal in a planar state is fixed in that state when the voltage is reduced to zero.

On the other hand, where the focal conic state is to be ultimately selected, selection pulses of ± (Vs·Vc) voltage are impressed during the selection sub-period, and cross-talk pulses of ±Vc voltage are impressed during the post-selection sub-period as in the case where the planar state is to be selected. In this way, the liquid crystal molecules become twisted again and enter a transition state in which the helical pitch is approximately doubled.

When the maintenance waveform is impressed during the establishing period, the twisting molecules of the liquid crystal shift to the focal conic state. During the display period, the voltage impressed to the liquid crystal is reduced to zero or ±Vc (cross-talk pulses), as in the case in which the planar state is to be selected. Liquid crystal in a focal conic state becomes fixed in that state when the voltage is reduced to zero.

As described above, the final display state of the liquid crystal may be selected based on the selection pulses impressed during the selection period. In addition, by adjusting the voltage level of the selection pulses, or specifically, by changing the pulse form (voltage level) impressed to each signal electrode based on the image data, halftone display may be obtained. An example in which halftone display may be obtained by adjusting the voltage level of the selection pulses was explained here, but halftone display may also be obtained by adjusting the pulse width of the selection pulses.

The liquid crystal is observed as essentially transparent from the onset of the reset period to the completion of the establishing period, so that the light-absorbing layer 121 in the background is observed.

The time necessary for the liquid crystal to shift from the homeotropic state to the transition state, in which the molecules thereof become untwisted and the helical pitch is roughly doubled, varies depending on the liquid crystal material. Where the selection period is too short, even if selection pulses of ±(Vs·Vc) voltage are impressed, the transition state is not obtained within the selection period, such that the focal conic state cannot be selected. Where the selection period is too long, the liquid crystal shifts from the homeotropic state to the planar state within the selection period, and consequently the focal conic state cannot be selected.

Therefore, in this drive method, the pre-selection sub-period and the post-selection sub-period are varied depending on the type of the liquid crystal present in each display layer 111D, 111G and 111R. In order to vary these periods, the length of each selection sub-period is adjusted based on the position of the pre-selection pulse width adjustment timing, which comprises the border between the reset period and the selection period, and the position of the post-selection pulse width adjustment timing, which comprises the border between the selection period and the establishing period.

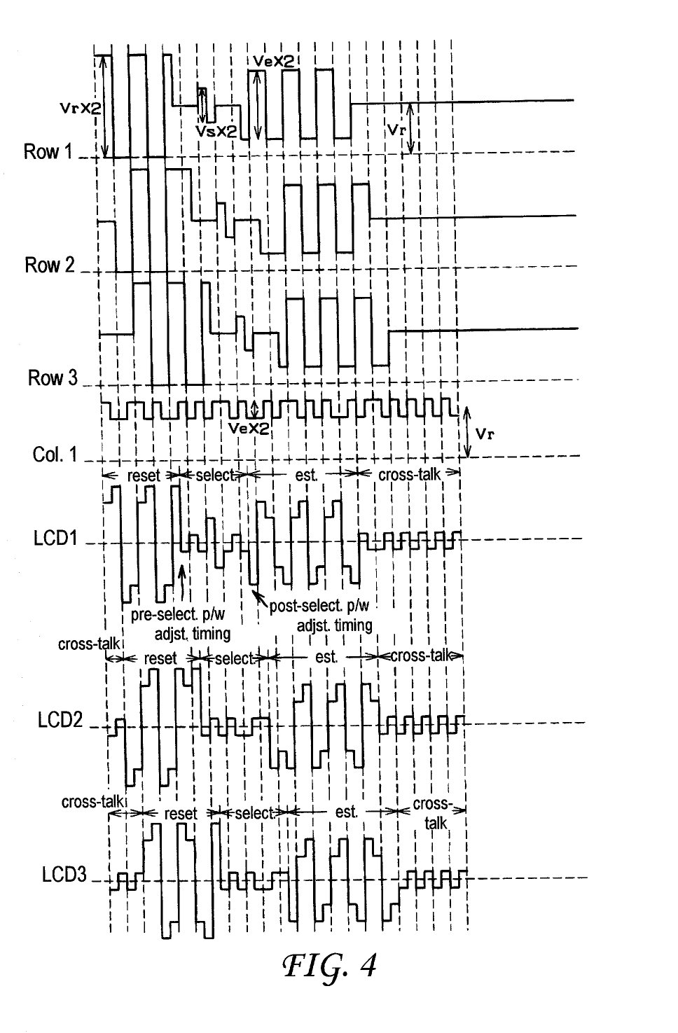

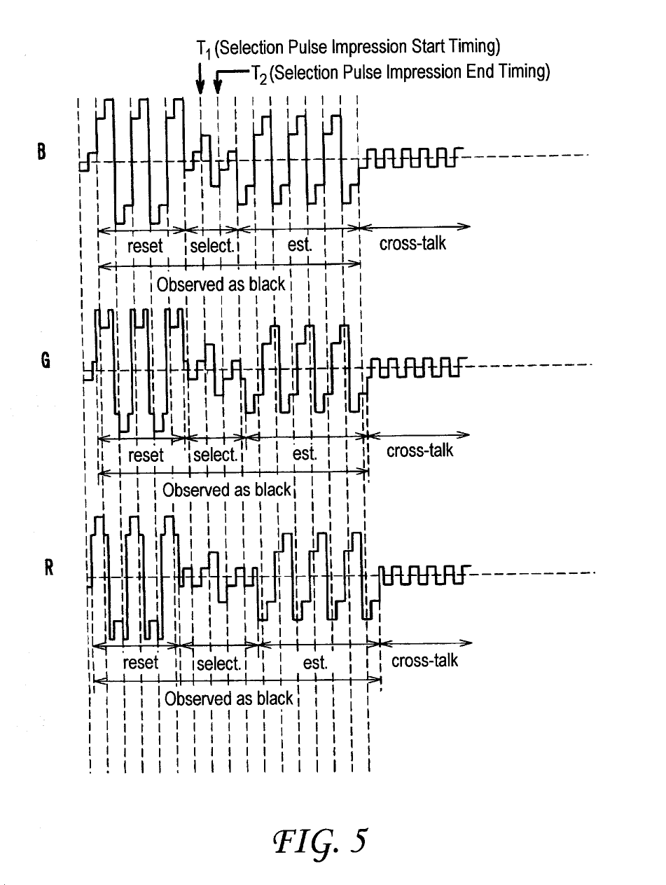

(First Embodiment, see FIGS. 4 and 5)

In the first embodiment, the widths of the selection pulses impressed in each display layer R, G and B were made identical so that the display layers have the same scanning speed. FIG. 4 shows one example of drive voltage waveforms impressed to the liquid crystal of LCDs 1, 2 and 3, which have a matrix of multiple pixels, and of the pulse waveforms impressed from the scanning electrodes (rows) and the signal electrodes (columns) to obtain the above waveforms. Rows 1, 2 and 3 each indicate one scanning electrode and the column indicates one signal electrode.

In this first embodiment, pulses having twice the cycle of the selection pulse width are impressed to the rows during the reset period and the establishing period. Pulses having the same cycle as the selection pulse width are impressed to the column.

FIG. 5 shows the voltage waveforms impressed to the pixels of the display layers R, G and B located on the same scanning line. The longer it takes for the liquid crystal molecules to become twisted, the longer the pre-selection sub-period and post-selection sub-period are set to be. In the liquid crystal display element 100, the time required for the liquid crystal molecules to become twisted is progressively longer in the order of the display layers 111B. 111G and 111R, and therefore the selection period is set to be progressively longer in this order as well.

The display layer 111R, which has the longest selection period, enters the reset period first. When this occurs, the display layers 111B and 111G are in the display period, such that cross-talk pulses are being impressed to them. The display layer 111G then enters the reset period, and the display layer 111B enters the reset period last. After the reset period, which is the same length for all of the display layers, each display layer sequentially enters the selection period, in which they go through the pre-selection sub-period and enter the selection sub-period during which selection pulses are impressed. All of the display layers enter and exit the selection sub-period at the same time (see arrows T₁ and T₂ in FIG. 5). After the post-selection sub-period, the display layers 111B, 111G and 111R, the selection periods of which are progressively longer in that order, sequentially enter the establishing period. After the establishing period, which is the same length for all of the display layers, the display layers 111B, 111G and 111R sequentially enter the display period in that order.

In the drive method of this first embodiment, the scanning speed is determined only by the length of the selection sub-period (the time period during which selection pulses are impressed). Therefore, even if the pre-selection sub-period and the post-selection sub-period are different from one display layer to another, so long as the selection pulse width is set to be the same, the scanning speed may be made equal for all of the display layers. Therefore, although the width of the band that appears black during image draw varies from one display layer to the next, the problem of the next image draw beginning before the image in one of the display layers is completed does not occur even when images are repeatedly drawn.

In addition, in this embodiment, the impression of selection pulses is carried out simultaneously, and therefore the timing at which display renewal begins may be the same at all times for all of the display layers. Furthermore, in this embodiment, because the timing at which the polarity of the impressed voltage reverses during the reset period and the establishing period varies from one display layer to another, the amount of current that is drawn at any one time is reduced. Further, because the impression of selection pulses begins at the same time, even where the display is renewed repeatedly, display discrepancies and discrepancies between images of different colors do not occur among the three display layers.

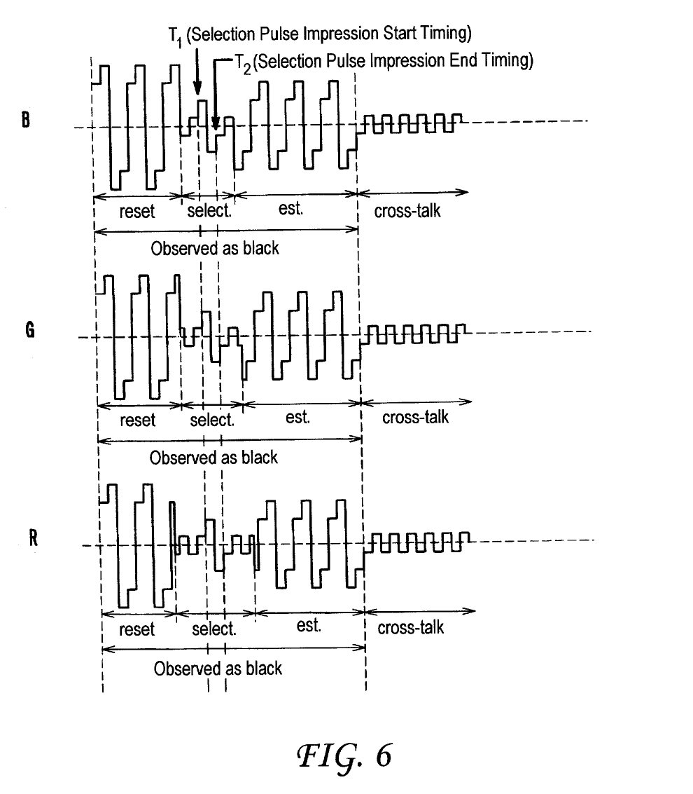

(Second Embodiment, see FIG. 6)

In the second embodiment, the total time of the reset period, selection period and establishing period is made equal for all of the display layers R, G and B. FIG. 6 shows the voltage waveforms impressed to the pixels of each display layer R, G and B located on the same scanning line in the same manner as FIG. 5.

In the second embodiment, the reset period simultaneously begins for the display layers 111B, 111G and 111R, and the display layers 111R, 111G and 111B enter the selection period in that order because the selection periods for those layers are progressively shorter in that order. The three display layers enter the selection sub-period at the same time, i.e., selection pulses are impressed in the three display layers at the same time, and the display layers enter the establishing period in the order of 111B, 111G and 111R, in which order the selection period is progressively longer. Subsequently, the three display layers simultaneously enter the display period.

In the second embodiment, the length of the interval between the commencement of the reset period to the completion of the establishing period is set to be equal for all of the display layers by adjusting the pre-selection pulse width adjustment timing and the post-selection pulse width adjustment timing so that the longer the selection period is, the more the reset period and the establishing period are reduced. The reset period and the establishing period may become long in principle so long as a minimum length of period that is necessary to establish the final display state selected through the reset and selection pulses may be secured. Therefore, if these periods are set to be sufficiently long in advance, reset and establishment of the display state are not affected when these periods are reduced by the necessary degree for each display layer.

In the drive method of the second embodiment, the timing at which scanning begins and the scanning speed may be made equal for all of the display layers by having each display layer have the same selection sub-period length and the same timing at which selection pulses are impressed. Therefore, the widths of the band that appear black during image draw also become equal among the three display layers.

(Other Embodiment)

The liquid crystal display device and the liquid crystal display element drive method pertaining to the present invention are not limited to the embodiments described above, and may be varied within the essential scope of the invention.

For example, any construction, materials, and manufacturing method may be used for the liquid crystal display element, which may comprise stacked layers other than the three layers of R, G and B.

In particular, the length of the selection period for each display layer is unique to the liquid crystal material used, and is not limited to the examples of the embodiments. The cycle of the reset waveform and the maintenance waveform is not limited to twice the cycle of the selection pulses, and the cycle of the reset waveform and the cycle of the maintenance waveform may be different from each other.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A drive method for a liquid crystal display element that comprises multiple display layers that are stacked together and in each of which pulses of drive voltage are impressed to the liquid crystal via multiple scanning electrodes and multiple signal electrodes that face each other and are aligned in a perpendicular fashion, wherein a drive procedure is carried out for each display layer, said procedure including a reset period during which the liquid crystal is reset to the initial condition, a selection period during which the final display state is selected, an establishing period during which the state selected during the selection period is established, and wherein a length of time of selection pulses that are to be impressed during the selection period is set to be equal for each display layer.

2. A drive method as claimed in claim 1, wherein lengths of time of the selection periods for the multiple display layers are set independently.

3. A drive method as claimed in claim 2, wherein each of the selection periods consists of a pro-selection sub-period, a selection sub-period during which the selection pulses are to be impressed, and a post-selection sub-period carried out in this order, and wherein lengths of time of the pre-selection sub-periods for the multiple display layers and/or lengths of time of the post selection sub-periods for the multiple display layers are set independently.

4. A drive method as claimed in claim 1, wherein a total time of the reset period, the selection period, and the establishing period for one of the multiple display layers is set to be equal to those of the remaining ones of the multiple display layers.

5. A drive method as claimed in claim 4, wherein lengths of time of the reset periods for the multiple display layers and/or lengths of time of the establishing periods for the multiple display layers are set to be mutually different.

6. A drive method as claimed in claim 1, wherein lengths of time of the reset periods for the multiple display layers are set to be equal each other, and wherein lengths of time of the establishing periods for the multiple display layers are set to be equal each other.

7. A drive method as claimed in claim 1, wherein the selection periods for the multiple display layers are simultaneously carried out.

8. A liquid crystal display device comprising:
a liquid crystal display element comprising multiple display layers that are stacked together, wherein each layer comprises liquid crystal held between multiple scanning electrodes and multiple signal electrodes that face each other and are aligned in a perpendicular fashion; and
a drive unit that impresses pulse voltage to the liquid crystal of each display layer via the scanning electrodes and signal electrodes in order to cause each display layer to perform display, said driver unit carrying out for each display layer a drive procedure including a reset period during which the liquid crystal is reset to the initial condition, a selection period during which the final display state is selected, an establishing period during which the state selected in the selection period is established,
wherein a length of time of selection pulses that are to be impressed during the selection period is set to be equal for each display layer.

9. A liquid crystal display device as claimed in claim 8, wherein lengths of time of the selection periods for the multiple display layers are set independently.

10. A liquid crystal display device as claimed in claim 9, wherein each of the selection periods consists of a pre-selection sub-period, a selection sub-period during which the selection pulses are to be impressed, and a post-selection sub-period carried out in this order, and wherein lengths of time of the pre-selection sub-periods for the multiple display layers and/or lengths of time of the post selection sub-periods for the multiple display layers are set independently.

11. A liquid crystal display device as claimed in claim 8, wherein a total time of the reset period, the selection period, and the establishing period for one of the multiple display layers is set to be equal to those of the remaining ones of the multiple display layers.

12. A liquid crystal display device as claimed in claim 11, wherein lengths of time of the reset periods for the multiple display layers and/or lengths of time of the establishing periods for the multiple display layers are set to be mutually different.

13. A liquid crystal display device as claimed in claim 8, wherein lengths of time of the reset periods for the multiple display layers are set to be equal each other, and wherein lengths of time of the establishing periods for the multiple display layers are set to be equal each other.

14. A liquid crystal display device as claimed in claim 8, wherein the selection periods for the multiple display layers are simultaneously carried out.
